(19) United States
(12) Patent Application Publication
(10) Pub. No.: US 2015/0099040 A1
(43) Pub. Date: Apr. 9, 2015

(54) PRE-COATED FOOD FLAKES FOR A FOOD PRODUCT AND A METHOD OF MAKING A FOOD PRODUCT

(71) Applicant: Frito-Lay North America, Inc., Plano, TX (US)

(72) Inventor: Hanny Kanafani, Plano, TX (US)

(73) Assignee: Frito-Lay North America, Inc., Plano, TX (US)

(21) Appl. No.: 14/049,969

(22) Filed: Oct. 9, 2013

(51) Int. Cl. A23L 1/00

(52) U.S. Cl. CPC A23L 1/0047
USPC 426/92; 426/96; 426/99; 426/93; 426/292

(57) ABSTRACT

A topping for snack food products comprising large food flakes pre-coated with an adhesive and a method for applying the pre-coated food flakes to a food substrate to produce a topped snack food product. The food substrate may be any savory shelf-stable food known in the art such as a chips, pretzels, crispy bread products, popcorn, or nuts. The food flakes may be pieces of vegetables, fruits, meats, cheeses, grains, herbs or spices that complement the food substrate. The pre-coated food flakes are heated to partially liquefy the adhesive coating and then are applied to the food substrates. The topped food substrate is then subjected to changed process conditions to harden the adhesive, forming a bond between the food flakes and the food substrate.

### BACKGROUND OF THE INVENTION

1. Technical Field

The present invention relates to shelf-stable large food flakes coated with a solidified adhesive for adherence to a food substrate and a method of applying the food flakes to produce a snack food product.

2. Description of Related Art

Seasoning powders are often added to snack foods in order to provide taste and likeability. Snack foods include potato chips, tortilla chips, extruded snacks, pretzels, bread snacks, crackers, popcorn, and numerous other foodstuffs. Seasonings used, usually in a powdered form, have included salt, cheese and/or other dairy powders, tomato powder, chili powder, garlic powder, and onion powder, among many others. However, there is often an undesirable separation of the seasoning powder from the snack food. The separation occurs because of insufficient adhesion of the seasoning powders to the snack food. The problem of separation increases with the size and weight of the individual particles of the seasoning blend, and is most pronounced when large seasoning particles are used.

One way this problem has been approached in the past was by using oil as an adhesive to adhere particulate seasonings to a base or substrate. For example U.S. Pat. No. 6,534,102 B2, issued to Kazemzadeh, discloses a seasoning bit that, following extrusion and cooking is immersed into an oil and seasoning slurry at an elevated temperature. The product is then dry-coated with seasonings or sprayed with hot or room temperature oils and fats either carrying seasonings or the seasonings are applied as dusting on the surface while the oil and fats are used to adhere the seasoning to the surface. One drawback to using only oil, however, is that the adhesive strength of traditional oil mixes is not strong enough to adhere large three-dimensional bits to a substrate surface. In certain applications, large three-dimensional bits are desirable because they enable packaged snack chips to emulate another topped product including, but not limited to a pizza with toppings, a nacho chip, or a tostada.

Another prior art composition used to adhere particulates to a food product is U.S. Pat. No. 3,689,290 issued to Blackenstock et at which discloses using a coating agent comprised of dry corn syrup solids to adhere small particle sizes of food toppings to a substrate. The Blackenstock Patent discloses a particle size of the food topping as being 12-100 mesh, which corresponds to a particle size range of 0.150 to 1.68 millimeters (0.0059 to 0.0661 inches). Again, these are relatively small particle sizes that are being adhered to a substrate. The adhesive is not strong enough to adhere a substantial amount of larger three-dimensional particles to the chip.

U.S. Patent Application 2002/0187220 A1 discloses an edible particulate adhesive comprising maltodextrin, an edible surfactant, a solvent, a polysaccharide, and a modified starch. The invention, however, is clearly aimed at very small particulate adhesion. The invention indicates the preferred particle size is less than 650 micrometers. Thus, this invention also fails to adhere relatively large bits to a chip.

Another prior art composition used to adhere flavorings to a foodstuff is illustrated by European Patent EP 0 815 741 A2 which discloses a hot melt composition comprising a starch, such as corn syrup, maltodextrin, or an amylase-treated starch, and a plasticizer, such as a polyol or a polyacetic acid. Like the other inventions, this invention was also designed to adhere powdery-type particulate additives to foodstuffs such as salt, sugar, cheese powder, and ranch seasonings. Like other inventions in the prior art, it also fails to adhere relatively large bits to chips.

U.S. Pat. No. 7,074,445 discloses a method for adhering large seasoning bits to a food substrate wherein seasoning bits are coated with vegetable oil as a temporary adhesive to adhere a dry adhesive comprising corn syrup solids to the seasoning bits. The coated seasoning bits are applied to a substrate and sent through an oven or series of ovens to heat the dry adhesive and trigger its glass transition stage, so that the adhesive flows down around the bit. As the substrates are cooled, the adhesive undergoes another glass transition phase back to a solid which hardens the adhesive and adheres the bit to the food substrate surface. While effective at adhering large particles to a food substrate, the adhesive used has several drawbacks in that: a) it requires further processing steps after application, incurring significant additional capital; b) the heating required to trigger its glass transition causes formation of undesirable chemicals such as acrylamide; and c) it typically includes ingredients (e.g., corn syrup solids, maltodextrins, polysaccharides) that impart a sweet taste, which is undesirable for savory snack products.

Consequently a need exists for a method to adhere large food particulates, bits, fragments, flakes, or morsels to a food substrate that does not present the drawbacks previously described. The method should allow a snack food to demonstrate the characteristic look, texture, and taste of an emulated topped food product, yet be highly resistant to separation. The method should be adaptable to a product manufacturing line wherein the addition of the large particles occurs at a step after substantial cooking of the underlying food substrate and does not require further heating of the food substrate after the application of the adhesive.

### SUMMARY OF THE INVENTION

The present invention provides food flakes for adhering to the surface of a snack food substrate to produce a savory and hearty snack food product with a visual impact for consumers. The food flakes are coated with an adhesive that is solid under ambient conditions and shelf-stable for storage and transport. In one embodiment, the adhesive is an oil or oil blend having adhesive properties. In another embodiment, the oil blend is a dairy-based, oil-joining adhesive. The food substrate may be any savory shelf-stable snack food product known in the art, and the food flakes used can be pieces of vegetables, fruits, meats, cheeses, grains, herbs or spices that complement the food substrate. The food pieces may be pieces cut from the food as defined by local regulations (“natural” flakes) or formed from preparations to mimic the food (“formed” flakes).

This invention also provides a method of producing the snack food products whereby the adhesive coating on the flakes is heated to above its phase transition temperature to obtain a liquefied adhesive, and the food flakes are applied to the food substrates. The topped food substrates are then cooled below the phase transition temperature of the adhesive, which hardens the adhesive and substantially adheres the food flakes to the food substrate.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flowchart of one embodiment of the inventive method producing pre-coated food flakes;

FIG. 2 is a flowchart of one embodiment of the inventive method producing a topped snack food product; and

FIG. 3 is a flowchart of another embodiment of the inventive method producing a topped snack food product.

### DETAILED DESCRIPTION OF THE INVENTION

Several embodiments of Applicants' invention will now be described with reference to the drawings. Unless otherwise noted, like elements will be identified by identical numbers throughout all figures. The invention illustratively disclosed herein suitably may be practiced in the absence of any element which is not specifically disclosed herein.

The present invention provides shelf-stable food flakes pre-coated with an adhesive to be used as a topping for adherence to a food substrate and a method for making a snack food product with the pre-coated food flakes. The adhesive used herein allows larger food flakes than that disclosed in the prior art to be adhered to the surface of a food substrate. The resulting snack food product is a savory and hearty snack topped with food flakes that provide a visual impact for consumers and deliver taste and appearance.

The food substrate can be any savory snack food product known in the art, such as tortilla chips, potato chips, corn chips, extruded snacks, pretzels, crispy breads, popcorn, nuts, or nut clusters. In one embodiment, the food substrate is a savory shelf-stable snack food with a moisture content of less than about 3% by weight. The food flakes chosen can be any type of food, such as vegetable pieces, fruit pieces, meat pieces, grains, herbs, spices, or cheese shreds, or any combination of those, that complement the flavor of the food substrate or contribute to the flavor and appearance of the desired final snack food product. As used herein, the terms “flakes,” “pieces,” and “bits” are used interchangeably. The food flakes may be natural, meaning that the flakes are obtained from the natural food as defined by local regulations, or formed, meaning that the flakes are shaped from preparations from the natural food or a formulation made to replicate the natural food. Examples of food flakes that can be used are tomato pieces, carrot pieces, olive pieces, mushroom pieces, onion pieces, beet pieces, jalapeno pieces, green chili pieces, sweet pepper pieces, bacon pieces, chicken pieces, beef pieces, fish pieces, calamari pieces, shellfish pieces, caviar pieces, oats, cheddar cheese shreds, mozzarella cheese shreds, gouda cheese shreds, spicy pepper flakes, chili flakes, dill flakes, parsley flakes, basil flakes, garlic pieces, paprika flakes, rosemary flakes, mint flakes, black pepper pieces, curry leaf flakes, caraway seeds, sesame seeds, or poppy seeds. The food flakes may also be culinary preparations or cuisine recipes, such as lasagna, pizza, or grilled meats, processed into flakes or pieces.

In one embodiment, the adhesive used is an oil or a blend of oils, hereinafter referred to as an oil blend. The oil or oil blend may be selected from palm oil, kernel oil, canola oil, soybean oil, cottonseed oil, or a mixture thereof. In a preferred embodiment, palm oil, kernel oil, or a mixture thereof. The oil or oil blend is solid under ambient conditions and transitions to a liquid at about 90-110° F., hereinafter referred to as its phase transition temperature. Thus, the oil or oil blend acts as an adhesive as it solidifies. Other functional ingredients such as starches, gums, emulsifiers, dairy solids, and vegetable proteins, may be added to the oil or oil blend to increase its adhesive properties. The oil blend is formulated to have greater than 60% solids at room temperatures and less than 30% solids when the oil blend is heated to about 95. F. The solids amount of the oil blend, measured as percent solids fat content (% SFC), is critical so as to result in adhesion at room temperatures but are not perceivable by consumers upon consumption.

In one embodiment, the oil blend adhesive is a dairy-based adhesive, referred to herein as an oil-joining adhesive. The oil-joining adhesive is comprised of fractions of palm oil, kernel oil, or a combination thereof, blended with a cheese-based mixture comprised of cheddar cheese, whey, hydrogenated vegetable oil, butter, calcium stearate, buttermilk, salt, disodium phosphate, sunflower oil, natural flavors, and artificial flavors. The cheddar cheese is made of pasteurized milk, cheese cultures, salt, and enzymes, and the hydrogenated vegetable oil can be canola oil, cottonseed oil, or soybean oil. The oil fractions comprise about 45% to about 55% of the adhesive and the cheese-based mixture comprises about 45% to about 55% of the adhesive. The oil-joining adhesive has a phase transition temperature between about 95° F. and about 180° F. Thus, the oil-joining adhesive is solid at ambient conditions so it must be heated above its phase transition temperature to obtain a liquefied adhesive.

The food flakes are coated with a liquefied adhesive, which is then solidified, to obtain pre-coated food flakes. As used herein, pre-coated food flakes are shelf-stable food flakes substantially covered with, or encapsulated by, a coating of solidified adhesive. In one embodiment, the food flakes and the liquefied adhesive are combined in about a 1:1 ratio, such that the final pre-coated food flakes are about 30-70%, and preferably about 50%, by weight adhesive. In one embodiment, the uncoated food flakes have dimensions of about 4 to 20 millimeters in length, about 3 to 6 millimeters in width, about 2 to 4 millimeters in thickness, and a bulk density of about 0.2 to about 4.0 g/cc. The thickness of the coating of adhesive on the food flakes is generally not uniform and can range from a miniscule amount to about 2 millimeters. The pre-coating process can be done off-line or in a central location, and the pre-coated flakes may be stored at less than 100° F. Using pre-coated food flakes to produce topped snack food products allows less adhesive to be used than when the food flakes and adhesive are blended and applied to the food substrates. Another advantage is that the pre-coated food flakes may be stored, at temperatures under 100° F., for future use or transported to different processing centers for the production of topped snack food products.

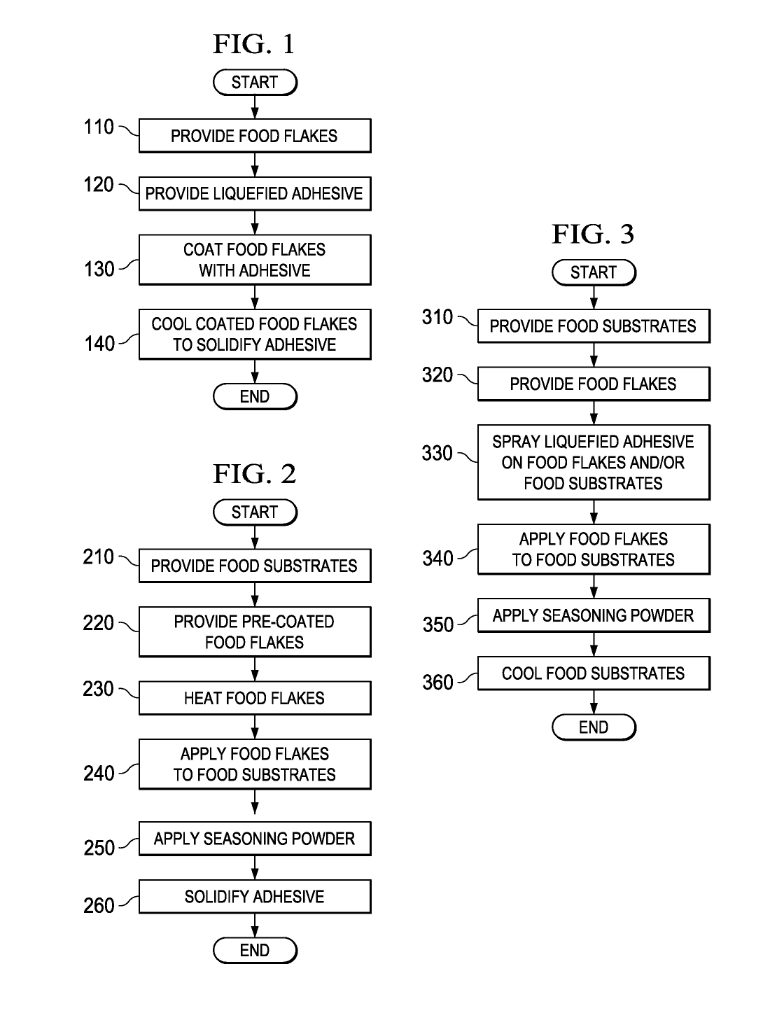

A method to produce the pre-coated food flakes will now be described with reference to FIG. 1. Food flakes are provided 110 to a fluidizing vessel. The food flakes are fluidized, or suspended in the air, by the introduction of air to the vessel. In a separate vessel, the adhesive is heated to between about 95° F. and about 180° F., more preferably between about 105° F. and about 125° F., to liquefy the adhesive. The liquefied adhesive is then introduced 120 into the fluidizing vessel, preferably as a mist. As the food flakes move through the fluidizing vessel, they are covered by a coating of adhesive 130. The coated food flakes are removed from the fluidizing vessel and exposed to cooler air to solidify the adhesive coating 140. During the solidifying phase, the food flakes must be kept apart from each other, either by fluidization or physical means, to avoid the formation of clumps of pre-coated food flakes. After the adhesive hardens, the pre-coated food flakes may be sent to further processing to produce the topped snack food products or stored for later use.

An embodiment of the inventive method to produce topped snack food products will now be described with reference to FIG. 2. A plurality of food substrates are provided 210 to a tumbler, seasoning drum, or other suitable vessel. Applicants will refer to a tumbler hereinafter for consistency and simplicity purposes, but this reference is not meant to limit the scope of the invention. A plurality of pre-coated food flakes are provided 220 to the tumbler, dispensed from a height at the receiving end of the tumbler. In one embodiment, the food flakes are dispensed from about 10-50 centimeters, more preferably about 10-30 centimeters, above the bed of food substrates. One skilled in the art will be able to determine the optimum height for dispensing the food flakes based on the heating system chosen, the equipment used, and the temperature of the food substrates. The pre-coated flakes are heated 230 such that the adhesive on the food flakes at least partially liquefies to be able to form a bond between the food flakes and the food substrates. The purpose of the heating step 230 is to soften or melt the coating of adhesive sufficiently so that the pre-coated flakes become tacky and adhere to the food substrates upon contact, but not enough that the adhesive falls off of the flakes. In one embodiment, the surface temperature of the food substrates provides sufficient heat to melt the adhesive as the pre-coated flakes contact the surfaces of the food substrates. In another embodiment, hot air is introduced into the tumbler to contact the food flakes and heat the adhesive as the flakes descend within the tumbler. The temperature profile of the hot air introduced into the tumbler must be such that the adhesive does not completely liquefy before the food flakes contact the food substrates or the adhesive will fall off of the food flakes, leading to insufficient adherence of the food flakes. In one embodiment, the stream of air introduced into the tumbler to contact the food flakes has a temperature of about 105° F. to about 135° F. In one embodiment, the air at the dispensing point of the food flakes has a temperature of less than about 95° F. and the air at the point of contact of the food flakes and the food substrates has a temperature of about 150° F. to about 300° F.

The food flakes, with the adhesive partially liquefied, are then applied 240 to the surfaces of the food substrates to obtain topped food substrates. The adhesive attaches to the surface of the food substrates due to its tackiness, and subsequently chemically and physically adheres the food flakes to the surface of the food substrates due to its lipophilic character. As the adhesive solidifies, it physically entraps the food flakes on the surface of the food substrates. As the topped food products travel through the tumbler, a seasoning powder is optionally applied 250 to the topped food substrates. It is preferable that the seasoning powder have a lipophilic character strong enough to bind to the adhesive and oily surface of the food substrate, but balanced so the seasoning powder does not compete for the lipophilic forces of the adhesive binding the food flakes to the food substrates. In one embodiment, the adhesive is substantially solidified prior to application of the seasoning powder to avoid the issue of competing lipophilic forces.

The adhesive is then solidified 260 on the topped snack food products, thereby substantially adhering the food flakes to the food substrates. To solidify the adhesive, the topped food substrates are cooled to below the phase transition temperature of the adhesive. The cooling step may be accomplished by exposing the snack products to ambient conditions or introducing cool air into the seasoning drum, where the cool air has a temperature less than about 95° F.

Another embodiment of the inventive method for production of topped snack food products will now be described with reference to FIG. 3. A plurality of food substrates are provided 310 to a tumbler. A plurality of food flakes are provided 320 to the tumbler, dispensed from a height at the receiving end of the tumbler. As described above, the food flakes are dispensed from about 10-50 centimeters, more preferably about 10-30 centimeters, above the bed of food substrates. One skilled in the art will be able to determine the optimum height for dispensing the food flakes based on the adhesive chosen, the equipment used, and the temperature of the food substrates. The food flakes may either be pre-coated food flakes or uncoated food flakes. As the food flakes descend towards the food substrates, a liquefied adhesive is sprayed 330 onto the food substrates and/or the food flakes. The liquefied adhesive may be an oil, oil blend, or oil-joining adhesive. When pre-coated food flakes are used, the liquefied adhesive partially liquefies the adhesive coating on the food flakes so that the adhesive will be able to bond the food flakes to the food substrates. In an embodiment in which uncoated food flakes are used, the liquefied adhesive substantially coats the food flakes upon application to allow the food flakes to adhere to the food substrates.

The food flakes are then applied 340 to the surfaces of the food substrates to form topped food substrates. As the topped food products travel through the tumbler, a seasoning powder is optionally applied 350 to the topped food substrates. The topped food substrates are cooled 360, solidifying the adhesive, and thereby substantially adhering the food flakes to the food substrates.

The final snack food product obtained by the inventive method thus contains a food substrate, solidified adhesive, food flakes, and seasoning powder. In one embodiment, the topped snack food product comprises, based on the weight of the topped snack food product, about 50 to 95% food substrate, about 10 to 50% coated flakes, and about 0 to 10% seasoning powder. In another embodiment, the topped snack food product comprises, based on the weight of the topped snack food product, about 65 to 90% food substrate, about 20 to 35% coated flakes, and about 2 to 7% seasoning powder.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A topping for a snack food product comprising food flakes having dimensions substantially between about 4-20 mm in length, about 3-6 mm in width, about 2-4 mm in thickness, and bulk density of 0.2-4.0 g/cc, wherein said food flakes are substantially coated with an adhesive, wherein said adhesive has a phase transition temperature of between about 90° F. to about 180° F., and further wherein said adhesive provides an adhering means for adhering said food flakes to a snack food product.

2. The topping of claim 1 wherein said adhesive comprises an oil or oil blend, wherein said oil or oil blend comprises palm oil, kernel oil, or mixtures thereof, and further wherein said adhesive has a phase transition temperature of between about 90° F. to about 110° F.

3. The topping of claim 1 wherein said oil blend comprises an oil-joining adhesive, wherein said adhesive has a phase transition temperature of between about 95° F. to about 180° F.

4. The topping of claim 1 wherein said food flakes comprise one or more vegetable pieces, fruit pieces, meat pieces, grains, herbs, spices, or cheese shreds.

5. The topping of claim 1 wherein said food flakes at least one selected from the group consisting of tomato pieces, carrot pieces, olive pieces, mushroom pieces, onion pieces, beet pieces, jalapeno pieces, green chili pieces, sweet pepper pieces, bacon pieces, chicken pieces, beef pieces, fish pieces, calamari pieces, shellfish pieces, caviar pieces, oats, cheddar cheese shreds, mozzarella cheese shreds, gouda cheese shreds, spicy pepper flakes, chili flakes, dill flakes, parsley flakes, basil flakes, garlic pieces, paprika flakes, rosemary flakes, mint flakes, black pepper pieces, curry leaf flakes, caraway seeds, sesame seeds, and poppy seeds.

6. The topping of claim 1 wherein said food flakes are natural.

7. The topping of claim 1 wherein said food flakes are formed.

8. A method for producing a topped snack food product, said method comprising the steps of:
a) providing a plurality of food substrates;
b) providing a plurality of pre-coated food flakes, wherein said food flakes are substantially covered with a coating of a solidified adhesive, wherein said adhesive has a phase transition temperature of between about 90° F. to about 180° F.;
c) heating said plurality of pre-coated food flakes to at least partially liquefy said adhesive;
d) applying said pre-coated food flakes to said food substrates to form topped food substrates; and
e) solidifying said adhesive on said topped food substrates, thereby substantially adhering said food flakes to said food substrates.

9. The method of claim 8 wherein said food flakes have dimensions substantially between about 4-20 mm in length, about 3-6 mm in width, about 2-4 mm in thickness, and bulk density of 0.2-4.0 g/cc.

10. The method of claim 8 wherein said adhesive comprises an oil or oil blend, wherein said oil or oil blend comprises palm oil, kernel oil, or mixtures thereof, and further wherein said adhesive has a phase transition temperature of between about 90° F. to about 110° F.

11. The method of claim 8 wherein said oil blend comprises an oil-joining adhesive having a phase transition temperature between about 95° F. and about 180° F.

12. The method of claim 8 wherein step e) comprises cooling said topped snack food products to a temperature below the phase temperature of said adhesive such that said adhesive solidifies and substantially adheres said food flakes to said food substrates.

13. The method of claim 12 wherein said cooling comprises exposing said plurality of food substrates to a stream of cool air, wherein said cool air has a temperature less than about 95° F.

14. The method of claim 8 further comprising the step of applying a seasoning powder to said plurality of topped food substrates prior to step e).

15. The method of claim 8 wherein said heating of step c) comprises contacting said food flakes with said food substrates.

16. The method of claim 8 wherein said heating of step c) comprises exposing said food flakes to a stream of air at a temperature of between about 105° F. and about 135° F.

17. The method of claim 8 wherein said plurality of food substrates comprise savory shelf-stable food products having a moisture content less than about 3%.

18. The method of claim 17 wherein said savory shelf-stable food products are selected from the group consisting of tortilla chips, potato chips, corn chips, pretzels, crispy breads, popcorn, nuts, or nut clusters.

19. The method of claim 8 wherein said food flakes comprise one or more vegetable pieces, fruit pieces, meat pieces, grains, herbs, spices, or cheese shreds.

20. The method of claim 8 wherein said food flakes at least one selected from the group consisting of tomato pieces, carrot pieces, olive pieces, mushroom pieces, onion pieces, beet pieces, jalapeno pieces, green chili pieces, sweet pepper pieces, bacon pieces, chicken pieces, beef pieces, fish pieces, calamari pieces, shellfish pieces, caviar pieces, oats, cheddar cheese shreds, mozzarella cheese shreds, gouda cheese shreds, spicy pepper flakes, chili flakes, dill flakes, parsley flakes, basil flakes, garlic pieces, paprika flakes, rosemary flakes, mint flakes, black pepper pieces, curry leaf flakes, caraway seeds, sesame seeds, and poppy seeds.

21. The method of claim 8 wherein said food flakes are natural.

22. The method of claim 8 wherein said food flakes are formed.

23. A method for producing a topped snack food product, said method comprising the steps of:
a) providing a plurality of food substrates;
b) providing a plurality of food flakes, wherein said food flakes have dimensions substantially between about 4-20 mm in length, about 3-6 mm in width, about 2-4 mm in thickness, and bulk density of 0.2-4.0 g/cc;
c) spraying said plurality of food substrates or said plurality of food flakes with a liquefied adhesive, wherein said adhesive has a phase transition temperature of between about 90° F. to about 180° F.;
d) applying said food flakes to said food substrates to form topped food substrates; and
e) cooling said topped food substrates, thereby substantially adhering said food flakes to said food substrates.

24. The method of claim 23 wherein said food flakes comprise pre-coated food flakes.

25. The method of claim 23 wherein said adhesive comprises an oil-joining adhesive having a phase transition temperature between about 95° F. and about 180° F.

26. The method of claim 23 wherein said adhesive comprises palm oil, kernel oil, or mixtures thereof, and further wherein said adhesive has a phase transition temperature of between about 90° F. to about 110° F.

27. The method of claim 23 wherein step e) comprises cooling said topped snack food products to a temperature below the phase temperature of said adhesive such that said adhesive solidifies and substantially adheres said food flakes to said food substrates.

28. The method of claim 27 wherein said cooling comprises exposing said plurality of food substrates to a stream of cool air, wherein said cool air has a temperature less than about 95° F.

29. The method of claim 23 further comprising the step of applying a seasoning powder to said plurality of topped food substrates prior to step e).

30. The method of claim 23 wherein said plurality of food substrates comprise savory shelf-stable food products having a moisture content less than about 3%.

31. The method of claim 30 wherein said savory shelf-stable food products are selected from the group consisting of tortilla chips, potato chips, corn chips, pretzels, crispy breads, popcorn, nuts, or nut clusters.

32. The method of claim 23 wherein said food flakes comprise one or more vegetable pieces, fruit pieces, meat pieces, grains, herbs, spices, or cheese shreds.

33. The method of claim 23 wherein said food flakes at least one selected from the group consisting of tomato pieces, carrot pieces, olive pieces, mushroom pieces, onion pieces, beet pieces, jalapeno pieces, green chili pieces, sweet pepper pieces, bacon pieces, chicken pieces, beef pieces, fish pieces, calamari pieces, shellfish pieces, caviar pieces, oats, cheddar cheese shreds, mozzarella cheese shreds, gouda cheese shreds, spicy pepper flakes, chili flakes, dill flakes, parsley flakes, basil flakes, garlic pieces, paprika flakes, rosemary flakes, mint flakes, black pepper pieces, curry leaf flakes, caraway seeds, sesame seeds, and poppy seeds.

34. The method of claim 23 wherein said food flakes are natural.

35. The method of claim 23 wherein said food flakes are formed.
